(19) United States
(12) Patent Application Publication
(10) Pub. No.: US 2015/0062727 A1
(43) Pub. Date: Mar. 5, 2015

(54) LENS AND LENS MODULE

(71) Applicant: SAMSUNG ELECTRO-MECHANICS CO., LTD., Suwon (KR)

(72) Inventor: Young Suk Kang, Suwon (KR)

(73) Assignee: SAMSUNG ELECTRO-MECHANICS CO., LTD., Suwon (KR)

(21) Appl. No.: 14/083,442

(22) Filed: Nov. 18, 2013

(30) Foreign Application Priority Data
Sep. 3, 2013 (KR) 10-2013-0105583

(51) Int. Cl. G02B 9/04

(52) U.S. Cl. CPC G02B 9/04
USPC 359/793

(57) ABSTRACT

There is provided a lens including: a first surface having a first coupling part formed thereon, the first coupling part having a staircase-shaped cross section; and a second surface having a second coupling part formed thereon, the second coupling part having an angle of inclination with respect to an optical axis.

### CROSS-REFERENCE TO RELATED APPLICATION

This application claims the benefit of Korean Patent Application No. 10-2013-0105583 filed on Sep. 3, 2013, with the Korean Intellectual Property Office, the disclosure of which is incorporated herein by reference.

### BACKGROUND OF THE INVENTION

1. Field of the Invention

The present invention relates to a lens and a lens module, and more particularly, to a lens and a lens module allowing for an optical axis to be easily aligned and decreasing a flare phenomenon due to internal reflection.

2. Description of the Related Art

There are two main methods of assembling a plurality of lenses in a lens barrel.

One method is a method of individually coupling the respective lenses to the lens barrel, while the other method is a method of only coupling one reference lens to the lens barrel and coupling the other lenses to the reference lens or subordinate lenses coupled to the reference lens.

Here, in the former method, since all of the lenses contact the lens barrel, it is necessary to precisely process the lenses and the lens barrel. Unlike this, in the latter method, since the plurality of lenses are self-aligned by an inclined surface formed at a flange part, the lenses are easily assembled and high lens processing precision is not required.

However, in the latter method, since light that is not required for forming an image may be reflected on the inclined surface for aligning the lenses, a flare phenomenon by which resolution is deteriorated is caused. Therefore, there is a need to develop a lens structure capable of significantly decreasing flare phenomenon generation while coupling a plurality of lenses to each other in a self aligning scheme.

For reference, as the related art related to the present invention, there are provided Patent Documents 1 and 2. Patent Documents 1 and 2 have introduced a structure for aligning a plurality of lenses by inserting each of the plurality of lenses into a lens barrel.

### RELATED ART DOCUMENT

(Patent Document 1) JP2005-513523 A
(Patent Document 2) JP2002-286987 A

### SUMMARY OF THE INVENTION

An aspect of the present invention provides a lens and a lens module having a structure capable of suppressing generation of a flare phenomenon while allowing lenses to be self-aligned.

According to an aspect of the present invention, there is provided a lens including: a first surface having a first coupling part formed thereon, the first coupling part having a staircase-shaped cross section; and a second surface having a second coupling part formed thereon, the second coupling part having an angle of inclination with respect to an optical axis.

The first and second coupling parts may be formed in flange parts enclosing optical parts, respectively.

The first coupling part may have the same angle of inclination as that of the second coupling part.

The first coupling part may have an angle of inclination different from that of the second coupling part.

The cross section of the first coupling part may have a staircase shape in which widths or heights are increased in an optical axis direction.

The cross section of the first coupling part may have a staircase shape in which widths or heights are decreased in an optical axis direction.

According to another aspect of the present invention, there is provided a lens including: a first surface having a first coupling part formed thereon, the first coupling part having a staircase-shaped cross section; and a second surface having a second coupling part formed thereon, the second coupling part having a curved surface shaped cross section.

The first and second coupling parts may be formed in flange parts enclosing optical parts, respectively.

The cross section of the first coupling part may have a staircase shape in which widths or heights are increased in an optical axis direction.

The cross section of the first coupling part may have a staircase shape in which widths or heights are decreased in an optical axis direction.

According to another aspect of the present invention, there is provided a lens module including: a first lens having a first coupling part formed thereon, the first coupling part having an angle of inclination with respect to an optical axis; and a second lens having a first coupling part formed thereon, the first coupling part having a staircase-shaped cross section.

The first coupling part of the first lens may be formed on one surface of the first lens facing the second lens, and the first coupling part of the second lens may be formed on one surface of the second lens facing the first lens.

The first lens may have a second coupling part formed on the other surface thereof, the second coupling part having a staircase-shaped cross section.

The first lens may have a second coupling part formed on the other surface thereof, the second coupling part having an angle of inclination with respect to the optical axis.

According to another aspect of the present invention, there is provided a lens module including: a first lens; a second lens aligned together with the first lens in an optical axis direction; and a gap maintaining member disposed between the first and second lenses and having a through-hole formed therein so as to connect an optical part of the first lens and an optical part of the second lens to each other, wherein the gap maintaining member has a first coupling part formed on one surface thereof, the first coupling part having an inclined surface, and the second lens has a first coupling part formed on one surface thereof, the first coupling part being coupled to the first coupling part of the gap maintaining member and having a staircase-shaped cross section.

The gap maintaining member may have a second coupling part formed on the other surface thereof, the second coupling part having an inclined surface, and the first lens may have a first coupling part formed on one surface thereof, the first coupling part being coupled to the second coupling part of the gap maintaining member and having an inclined surface.

The gap maintaining member may have a second coupling part formed on the other surface thereof, the second coupling part having an inclined surface, and the first lens may have a first coupling part formed on one surface thereof, the first coupling part being coupled to the second coupling part of the gap maintaining member and having a staircase-shaped cross section.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a lens according to an embodiment of the present invention;

FIG. 2 is an enlarged cross-sectional view of part A shown in FIG. 1;

FIGS. 3 through 5 are enlarged cross-sectional views showing modified forms of a first coupling part shown in FIG. 1;

FIG. 6 is a cross-sectional view showing another form of the lens shown in FIG. 1;

FIG. 7 is a cross-sectional view showing a form in which the lens shown in FIG. 1 and another lens are coupled to each other;

FIG. 8 is a cross-sectional view of a lens according to another embodiment of the present invention;

FIG. 9 is a cross-sectional view showing a form in which the lens shown in FIG. 8 and another lens are coupled to each other;

FIG. 10 is a cross-sectional view of a lens module according to the embodiment of the present invention;

FIG. 11 is an enlarged cross-sectional view of part B shown in FIG. 10;

FIG. 12 is a cross-sectional view of a lens module according to another embodiment of the present invention; and

FIG. 13 is an enlarged cross-sectional view of part C shown in FIG. 12.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

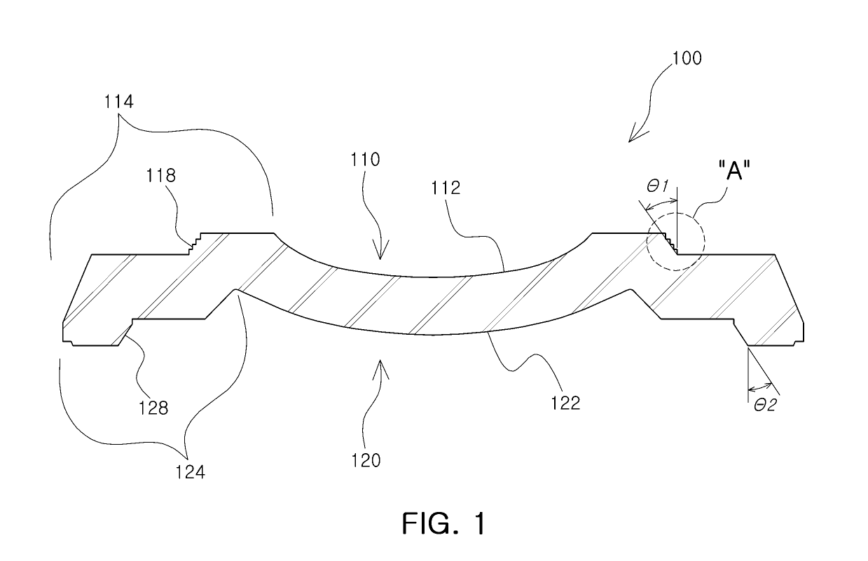

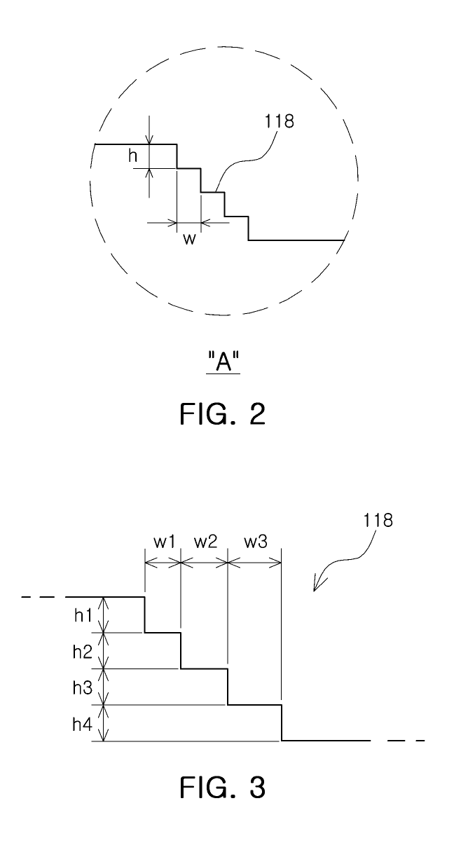

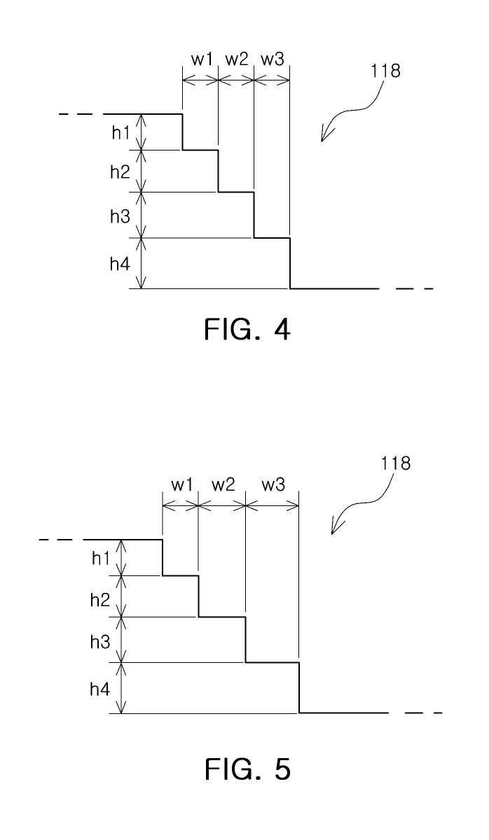

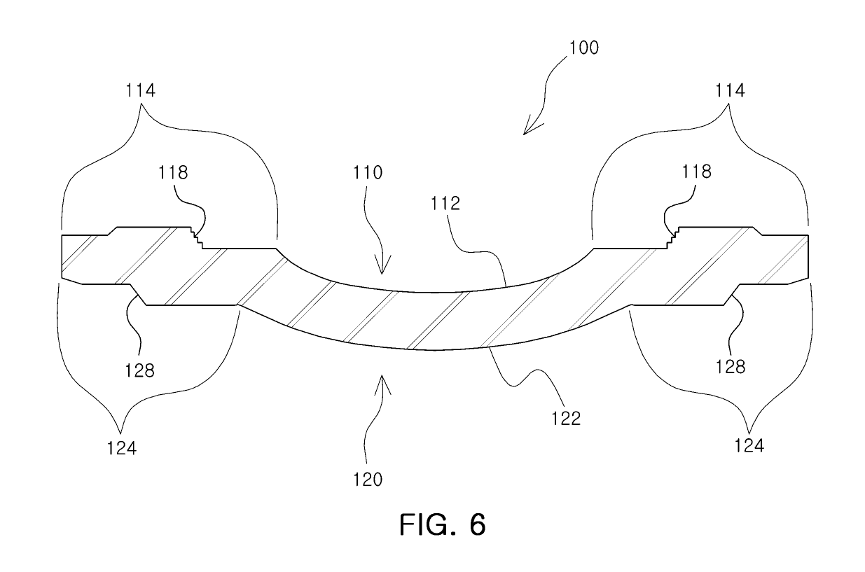

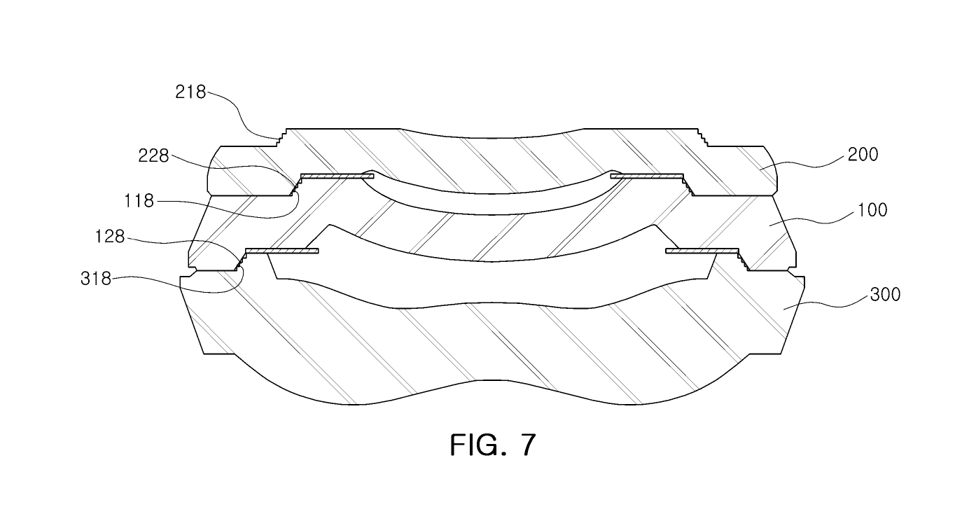

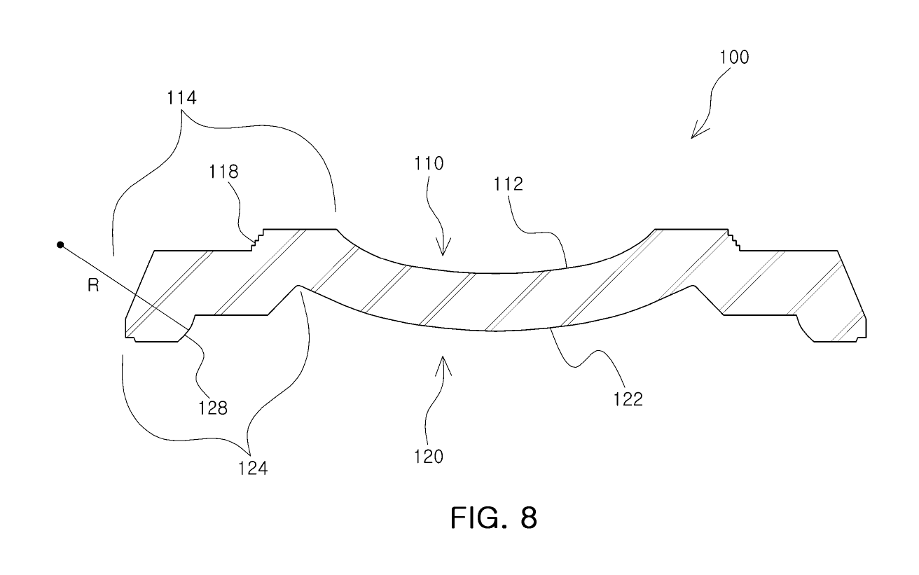

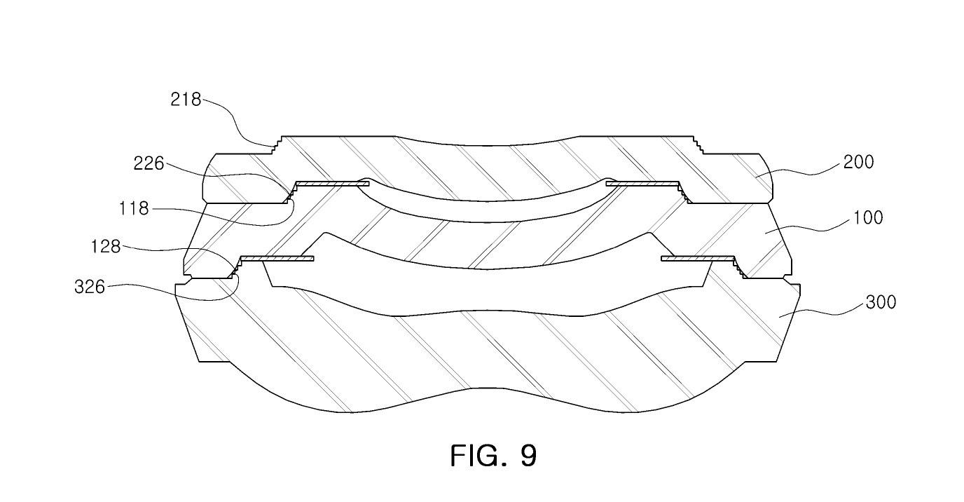

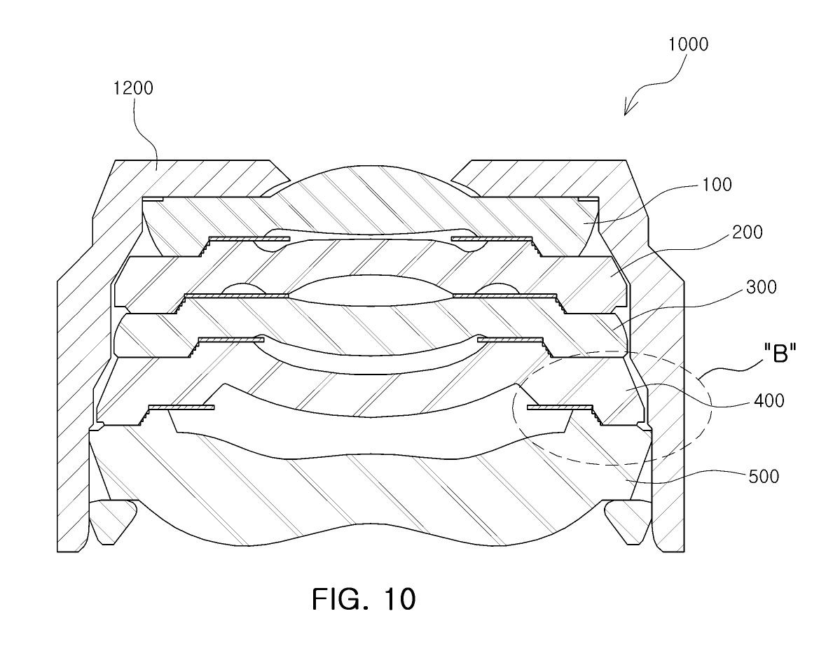

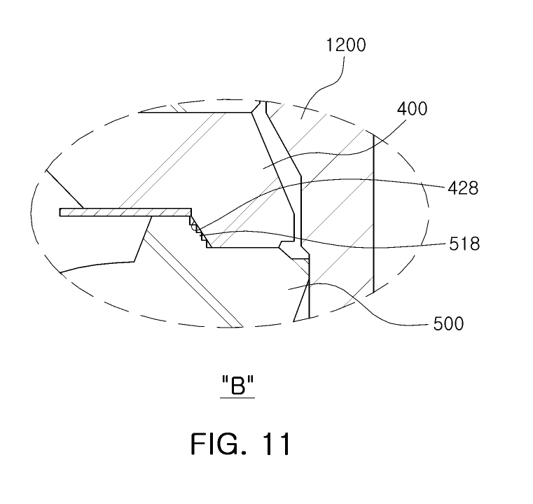

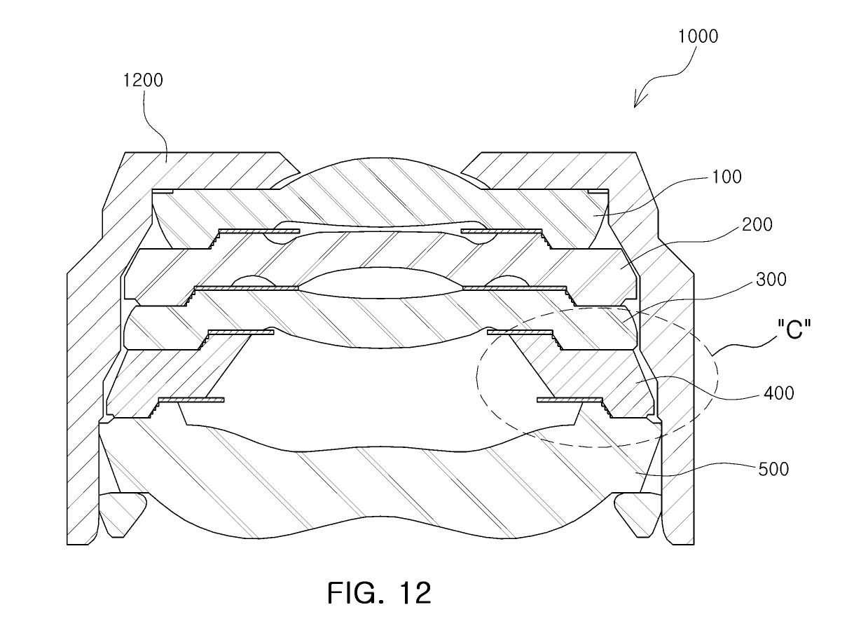

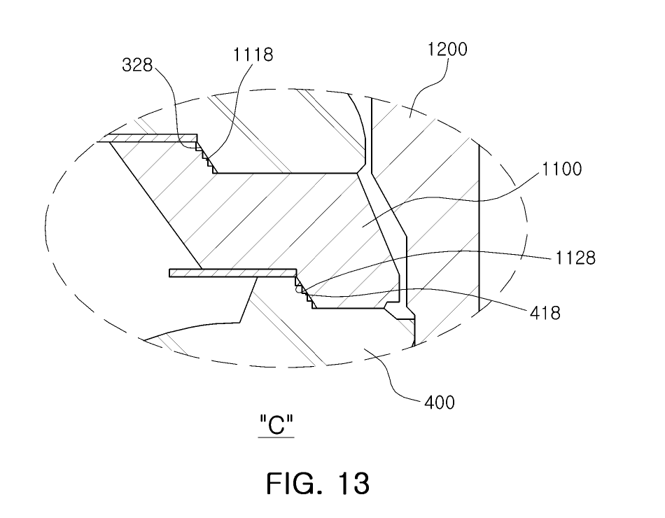

FIG. 1 is a cross-sectional view of a lens according to an embodiment of the present invention; FIG. 2 is an enlarged cross-sectional view of part A shown in FIG. 1; FIGS. 3 through 5 are enlarged cross-sectional view showing modified forms of a first coupling part shown in FIG. 1; FIG. 6 is a cross-sectional view showing another form of the lens shown in FIG. 1; FIG. 7 is a cross-sectional view showing a form in which the lens shown in FIG. 1 and another lens are coupled to each other; FIG. 8 is a cross-sectional view of a lens according to another embodiment of the present invention; FIG. 9 is a cross-sectional view showing a form in which the lens shown in FIG. 8 and another lens are coupled to each other; FIG. 10 is a cross-sectional view of a lens module according to the embodiment of the present invention; FIG. 11 is an enlarged cross-sectional view of part B shown in FIG. 10; FIG. 12 is a cross-sectional view of a lens module according to another embodiment of the present invention; and FIG. 13 is an enlarged cross-sectional view of part C shown in FIG. 12.

A lens according to the embodiment of the present invention will be described with reference to FIGS. 1 through 7.

The lens 100 according to the present embodiment may have a predetermined reflective index. To this end, the first lens 100 may have an optical part 112 or 122 formed on at least one of first and second surfaces 110 and 120. For example, the lens 100 may have the optical part 112 formed on the first surface thereof and have the optical part 122 formed on the second surface 120 thereof, wherein the optical part 112 may have a concave shape and the optical part 122 may have a convex shape. However, the shapes of the optical parts 112 and 122 are not limited to the above-mentioned shapes, but may be changed depending on a use and a position of the lens 100.

The lens 100 may be provided with flange parts 114 and 124. The flange part 114 or 124 may be formed in a manner in which it encloses the optical part 112 or 122 and provide a space in which the lens 100 and another lens or the lens 100 and other member (for example, a space maintaining member, a light shielding member, or a lens barrel) may contact each other.

The flange part 114 or 124 may have a structure formed in order to be coupled to another lens or another member (for example, lens barrel). More specifically, the lens 100 may have a first coupling part 118 formed on the first surface 110 thereof and have a second coupling part 128 formed on the second surface 120 thereof. Here, the second coupling part 128 may be omitted if necessary.

The first coupling part 118 may have a staircase-shaped cross section. More specifically, the coupling part 118 may have a cross section in which shapes having a predetermined heights h and a predetermined width w are repeated, as shown in FIG. 2. Here, surfaces forming the heights h may be substantially in parallel with an optical axis, and surfaces forming the widths w may be substantially perpendicular to the optical axis. In addition, all of the heights h and the widths w may be constant. The first coupling part 118 formed as described above may be coupled to a second surface of another lens to enable the lenses to be stacked and self-aligned.

The first coupling part 118 having the above-mentioned shape may suppress spill light (light impeding formation of a clear image of a subject) permeated into the lens 100 from being reflected to the optical parts 112 and 112 of the lens 100. Therefore, the lens 100 according to the present embodiment may significantly decrease a flare phenomenon.

Meanwhile, the cross-sectional shape of the first coupling part 118 may be changed into other shapes as shown in FIGS. 3 through 5. For example, the cross section of the first coupling part 118 may have a staircase shape in which heights h1 to h3 are constant (that is, h1=h2=h3), but widths w1 to w3 are increased or decreased, as shown in FIG. 3. Alternatively, the cross section of the first coupling part 118 may have a staircase shape in which widths w1 to w3 are constant (that is, w1=w2=w3), but heights h1 to h4 are increased or decreased, as shown in FIG. 4. Alternatively, the cross section of the first coupling part 118 may have a staircase shape in which both of heights h1 to h4 and widths w1 to w3 are increased or decreased, as shown in FIG. 5. The first coupling part 118 having various shapes as described above may be useful to couple the lens 100 and another lens to each other.

The first coupling part 118 may have a first angle of inclination θ1 with respect to the optical axis. Here, the first angle of inclination θ1 may be substantially the same as an angle of inclination θ2 of the second coupling part 128. However, the first and second angles of inclination θ1 and θ2 are not necessarily the same as each other, and may be different from each other if necessary.

The second coupling part 128 may be formed on the second surface 120 of the lens 100. More specifically, the second coupling part 128 may be formed in the flange part 124 of the second surface 120. The first second part 128 may have a predetermined angle of inclination θ2 with respect to the optical axis. That is, the second coupling part 128 may be a portion of a virtual conical figure centered on the optical axis. The second coupling part 128 formed as described above may be coupled to a first surface of another lens to enable the lenses to be stacked and self-aligned.

Meanwhile, the lens 100 may have a shape changed as shown in FIG. 6. That is, first and second coupling parts 118 and 128 may have an inclined direction different from that of the first and second coupling parts 118 and 128 of the lens 100 of FIG. 1.

Next, a coupled structure of the lens 100 according to the present embodiment will be described with reference to FIG. 7. For reference, lenses 200 and 300 shown in FIG. 7 may have a structure and a shape that are the same as or similar to that of the lens 100 described above. More specifically, a first coupling part 218 of the lens 200 may have a staircase-shaped cross section that is the same as or similar to that of the first coupling part 118 of the lens 100, and a first coupling part 318 of the lens 300 may have a staircase-shaped cross section that is the same as or similar to that of the first coupling part 118 of the lens 100. Likewise, a second coupling part 228 of the lens 200 may have an inclined surface that is the same as or similar to that of the second coupling part 128 of the lens 100.

Therefore, the lenses 100 and 200 and the lenses 100 and 300 may be constantly coupled to each other by a contact between the first coupling part 118 having the staircase-shaped cross section and the second coupling part 228 having the inclined surface and a contact between the first coupling part 318 having the staircase-shaped cross section and the second coupling part 128 having the inclined surface, respectively.

The lenses 100, 200 and 300 formed as described above may be stacked in an optical axis direction. In addition, the lenses 100, 200, and 300 are stacked and coupled to each other, such that optical axes of the lenses 100, 200, and 300 may be aligned in a self aligning scheme. More specifically, the optical axes of the first and second lenses 100 and 200 may be aligned by coupling between the first coupling part 118 and the second coupling part 228, and the optical axes of the first and third lenses 100 and 300 may be aligned by coupling between the second coupling part 128 and the first coupling part 318.

Meanwhile, reflection of spill light generated at a portion at which the lenses 100 and 200 or the lenses 100 and 300 are coupled may be removed or suppressed by the coupling parts 118, 218, and 318 having the staircase shape. That is, since the coupling parts 118, 218, and 318 having the staircase shape generally reflect the spill light in a direction in which the spill light is incident, a phenomenon in which the spill light is incident to an upper surface (that is, an upper surface of an image sensor) may be effectively blocked or decreased.

Next, a lens according to another embodiment of the present invention will be described with reference to FIGS. 8 and 9.

The lens 100 according to the present embodiment may be different in a shape of a second coupling part 128 from the lens according to the above-mentioned embodiment of the present invention.

The second coupling part 128 according to the present embodiment may have a cross-sectional shape including at least one curved line. That is, the second coupling part 128 may have a cross-sectional shape including one curved line having a predetermined radius R or at least two curved lines having different radii.

The second coupling parts 128 and 228 having the above-mentioned shape may always line-contact the first coupling parts 318 and 118 having the staircase-shaped cross section (See FIG. 8). Therefore, the lenses 100, 200, and 300 having the shapes according to the present embodiment may be more easily coupled to each other.

In addition, since the second coupling parts 128 and 228 according to the present embodiment may also be formed as any curved line, the second coupling parts 128 and 228 may be easily processed.

Next, lens modules according to an embodiment and another embodiment of the present invention will be described.

A lens module according to the embodiment of the present invention will be described with reference to FIGS. 10 and 11. For reference, lenses configuring a lens module to be described below will be denoted by reference numbers 100, 200, 300, 400, and 500 and may have shapes that are the same as or similar to those of the above-mentioned lenses.

The lens module 1000 according to the present embodiment may include a plurality of lenses 100, 200, 300, 400, and 500. In addition, the lens module 1000 may further include a lens barrel 1200 receiving the above-mentioned lenses 100, 200, 300, 400, and 500 therein. Further, the lens module 1000 may further include a shielding member. Further, the lens module 1000 may further include a press-fitting ring for preventing separation of the lenses 100, 200, 300, 400, and 500 received in the lens barrel 1200.

The lens module 1000 may have a structure in which the lenses 100, 200, 300, 400, and 500 may be self-aligned. To this end, the first and fifth lenses 100 and 500 may physically contact the lens barrel 1200, and the other lenses 200, 300, and 400 may not physically contact the lens barrel 1200. More specifically, the second lens 200 is coupled to the first lens 100, such that a position of the second lens 200 may be aligned, the third lens 300 is coupled to the second lens 200, such that a position of the third lens 300 may be aligned, and the fourth lens 400 is coupled to the third lens 300, such that a position of the fourth lens 400 may be aligned. Further, the fifth lens 500 is coupled to the lens barrel 1200 simultaneously with being coupled to the fourth lens 400, such that a position of the fifth lens 500 may be aligned.

The first and second coupling parts may be formed at each of the first to fifth lenses 100 to 500. More specifically, the first coupling part may be formed on each of first surfaces (surfaces toward the right in FIG. 10) of the first to fifth lenses 100 to 500, and the second coupling part may be formed on each of second surfaces (surfaces toward the left of FIG. 10) of the first to fifth lenses 100 to 500.

Here, the first coupling part 518 may have a staircase-shaped cross section as shown in FIG. 11. In addition, the second coupling part 428 may have a cross section having a predetermined angle of inclination with respect to the optical axis.

The first coupling part 518 and the second coupling part 428 formed as described above may be coupled to each other by a linear contact to coupling adjacent lenses 400 and 500 to each other and align the adjacent lenses 400 and 500. In addition, the first coupling part 518 having the staircase-shaped cross section may reflect spill light incident through internal reflection or a flange part as it is to prevent the spill light from being incident upwardly.

For reference, although the case in which the lens module 100 includes five lenses has been shown in FIG. 10, the number of lenses is not limited to five. That is, the number of lenses configuring the lens module 1000 may be increased or decreased if necessary.

Next, a lens module according to another embodiment of the present invention will be described with reference to FIGS. 12 and 13.

The lens module 1000 according to the present embodiment may be different in a shape of a gap maintaining member 1100 from the lens module according to the above-mentioned embodiment of the present invention. That is, the gap maintaining member 1100 according to the present embodiment may have a third coupling part 1118 and a fourth coupling part 1128 corresponding to the first coupling part 418 of the fourth lens 400 and the second coupling part 328 of the third lens 300, respectively.

The gap maintaining member 1100 formed as described above may block spill light incident to an upper surface while enabling the third and fourth lenses 300 and 400 to be self-aligned.

As set forth above, according to the embodiments of the present invention, the lenses may be self-aligned.

Further, according to the embodiments of the present invention, a flare phenomenon generated in the flange part of the lens may be decreased.

While the present invention has been shown and described in connection with the embodiments, it will be apparent to those skilled in the art that modifications and variations can be made without departing from the spirit and scope of the invention as defined by the appended claims.

What is claimed is:

1. A lens comprising:
a first surface having a first coupling part formed thereon, the first coupling part having a staircase-shaped cross section; and
a second surface having a second coupling part formed thereon, the second coupling part having an angle of inclination with respect to an optical axis.

2. The lens of claim 1, wherein the first and second coupling parts are formed in flange parts enclosing optical parts, respectively.

3. The lens of claim 1, wherein the first coupling part has the same angle of inclination as that of the second coupling part.

4. The lens of claim 1, wherein the first coupling part has an angle of inclination different from that of the second coupling part.

5. The lens of claim 1, wherein the cross section of the first coupling part has a staircase shape in which widths or heights are increased in an optical axis direction.

6. The lens of claim 1, wherein the cross section of the first coupling part has a staircase shape in which widths or heights are decreased in an optical axis direction.

7. A lens comprising:
a first surface having a first coupling part formed thereon, the first coupling part having a staircase-shaped cross section; and
a second surface having a second coupling part formed thereon, the second coupling part having a curved surface shaped cross section.

8. The lens of claim 7, wherein the first and second coupling parts are formed in flange parts enclosing optical parts, respectively.

9. The lens of claim 7, wherein the cross section of the first coupling part has a staircase shape in which widths or heights are increased in an optical axis direction.

10. The lens of claim 7, wherein the cross section of the first coupling part has a staircase shape in which widths or heights are decreased in an optical axis direction.

11. A lens module comprising:
a first lens having a first coupling part formed thereon, the first coupling part having an angle of inclination with respect to an optical axis; and
a second lens having a first coupling part formed thereon, the first coupling part having a staircase-shaped cross section.

12. The lens module of claim 11, wherein the first coupling part of the first lens is formed on one surface of the first lens facing the second lens, and
the first coupling part of the second lens is formed on one surface of the second lens facing the first lens.

13. The lens module of claim 12, wherein the first lens has a second coupling part formed on the other surface thereof, the second coupling part having a staircase-shaped cross section.

14. The lens module of claim 12, wherein the first lens has a second coupling part formed on the other surface thereof, the second coupling part having an angle of inclination with respect to the optical axis.

15. A lens module comprising:
a first lens;
a second lens aligned together with the first lens in an optical axis direction; and
a gap maintaining member disposed between the first and second lenses and having a through-hole formed therein so as to connect an optical part of the first lens and an optical part of the second lens to each other,
wherein the gap maintaining member has a first coupling part formed on one surface thereof, the first coupling part having an inclined surface, and
the second lens has a first coupling part formed on one surface thereof, the first coupling part being coupled to the first coupling part of the gap maintaining member and having a staircase-shaped cross section.

16. The lens module of claim 15, wherein the gap maintaining member has a second coupling part formed on the other surface thereof, the second coupling part having an inclined surface, and
the first lens has a first coupling part formed on one surface thereof, the first coupling part being coupled to the second coupling part of the gap maintaining member and having an inclined surface.

17. The lens module of claim 15, wherein the gap maintaining member has a second coupling part formed on the other surface thereof, the second coupling part having an inclined surface, and
the first lens has a first coupling part formed on one surface thereof, the first coupling part being coupled to the second coupling part of the gap maintaining member and having a staircase-shaped cross section.
